(19) United States
(12) Patent Application Publication
(10) Pub. No.: US 2013/0324663 A1
(43) Pub. Date: Dec. 5, 2013

(54) Nylon Compositions for Forming Cast Nylon and Cast Nylon Parts

(71) Applicant: ADVANCED NYLONS PTY. LTD., Randvaal (ZA)

(72) Inventor: Wilbur Cook, Randvaal (ZA)

(73) Assignee: Advanced Nylons PTY. LTD., Randvaal (ZA)

(21) Appl. No.: 13/789,653

(22) Filed: Mar. 7, 2013

Related U.S. Application Data
(60) Provisional application No. 61/655,865, filed on Jun. 5, 2012.

(51) Int. Cl. C08K 3/04; C08K 5/13; C08K 3/36

(52) U.S. Cl. CPC C08K 3/04; C08K 3/36; C08K 5/13
USPC 524/761

(57) ABSTRACT

A composition for forming a cast nylon part comprising a base caprolactam mixture and at least one of a first additive comprising acetylene carbon black; a second additive comprising at least one of nonyl phenol ethoxylate, silicon oil, and at least one nonionic surfactant having a viscosity similar to that of nonyl phenol ethoxylate; a third additive comprising silicon dioxide; and a fourth additive comprising intercalated expandable graphite.

### RELATED APPLICATIONS

This application (Attorney's Ref. No. P217383) claims benefit of U.S. Provisional Patent Application Ser. No. 61/655,865 filed Jun. 5, 2012, the contents of which are incorporated herein by reference.

### TECHNICAL FIELD

The present invention relates to nylon compositions for forming cast nylon and cast nylon parts and, more particularly, to nylon compositions that may be used to form cast nylon parts having improved flame retardance and/or anti-static properties.

### BACKGROUND

Cast nylon parts exhibit high tensile and compressive strength coupled with low co-efficient of friction. Cast nylon parts also are lightweight, are easily machinable, and exhibit high wear resistance. Cast nylon parts are thus suitable for use in place of parts made of metal and other plastics.

One characteristic of traditional cast nylon parts is that they are non-conductive and thus are susceptible to the build-up of static electricity. Cast nylon parts have thus traditionally not been used in environments in which the build-up of static electricity can be problematic. Conventional cast nylon parts are relatively flammable and thus may not be suitable for use in certain environments in which the part may be exposed to excessive heat.

Additionally, to use the full range of casting techniques (e.g., pour cast, reaction injection molded, and/or spun cast) and to manufacture cast nylon parts in a full range of shapes (rods, bars, tubes, plates, and custom shapes), the properties of the nylon material prior to polymerization must be maintained within certain parameters. For example, certain additives may sediment out during pour casting or be spun out by centrifugal forces during spin casting.

The need thus exists for compositions for forming cast nylon parts that are not susceptible to the build-up of static electricity, that are resistant to ignition when exposed to heat and/or flame, and that allow the full range of casting techniques.

### SUMMARY

The present invention may be embodied as a composition for forming a cast nylon part comprising a base caprolactam mixture and at least one of a first additive comprising acetylene carbon black, a second additive comprising at least one of nonyl phenol ethoxylate, silicon oil, and at least one nonionic surfactant having a viscosity similar to that of nonyl phenol ethoxylate, a third additive comprising silicon dioxide, and a fourth additive comprising intercalated expandable graphite.

The present invention may also be embodied as a method of forming a cast nylon part comprising the following steps. A base caprolactam mixture is provided. Added to the base caprolactam mixture is at least one of a first additive comprising acetylene carbon black, a second additive comprising at least one of nonyl phenol ethoxylate, silicon oil, and at least one nonionic surfactant having a viscosity similar to that of nonyl phenol ethoxylate, a third additive comprising silicon dioxide, and a fourth additive comprising intercalated expandable graphite.

### BRIEF DESCRIPTION OF THE DRAWINGS

FIG. 1 is a section view of an example material handling system incorporating roller structures formed of cast nylon compositions of the present invention;

FIG. 2 is a top plan view of the example material handling system depicted in FIG. 1;

FIG. 3 is a side elevation view of the example material handling system depicted in FIG. 1; and

FIG. 4 is a section view depicting the example roller structure used by the material handling system of FIG. 1.

### DETAILED DESCRIPTION

The present invention may be embodied as nylon compositions for forming cast nylon parts, a method of forming cast nylon parts, and/or the cast nylon parts formed by these compositions and methods. In the following detailed description of examples of the invention, the basic composition and several possible additives will first be described. Then, several example nylon compositions and methods of forming a cast nylon part will be described. Finally, one example of a cast nylon part adapted for use as an idler roller on a material handling system such as a conveyor belt will be described.

### I. NYLON COMPOSITIONS FOR FORMING CAST NYLON PARTS

A nylon composition of the present invention will comprise a base monomer, a catalyst as a polymerizing agent, an activator, and one or more additives to enhance certain properties of the cast nylon part formed by the nylon composition. The combination of the base monomer, the polymerization agent, and the activator will be referred to as the base mixture or base caprolactam mixture. A first additive may be used to provide conductivity to a nylon part that is otherwise non-conductive to provide the cast nylon part with anti-static properties. A second additive may be used to provide the cast nylon part with enhanced fire retardant properties. A third additive may be used as a thixotropic agent. A fourth additive may be used as an intumescent to provide additional fire retardant properties. The nylon composition of the present invention may thus be obtained by adding one or more of these additives to the base mixture.

The use of one or more of these additives may allow a cast nylon part to be used in environments in which nylon without these additives is not suited. For example, if a cast nylon part is used as a part of an idler roller of a conveyor system that is located in an enclosed environment (e.g., underground), the cast nylon part must resist the build-up of static electricity that could result in combustion and fire. Further, a cast nylon part used in this type of environment must be resistant to ignition when exposed to flames or heat. Accordingly, a cast nylon part using any one or all of the additives described herein will be more suitable for use in such environments than a cast nylon part without such additives.

In addition, conventional cast nylon has significant operating advantages, such as reduced weight, reduced friction, and acceptable compressibility in relation to other materials. The first and second additives should not significantly affect the operating characteristics of the cast nylon part.

Conventional cast nylon compositions may be cast in unlimited forms (e.g., stock forms such as rods, bars, tubes, and plates and custom shapes defined by a mold) using a number of different casting techniques (e.g., pour cast, reaction injection molded, and/or spun cast). And conventional finished cast nylon parts may further easily be machined or otherwise cut, drilled, or milled. Conventional cast nylon parts may further be spin-welded to other compatible cast nylon parts. The first and second additives should not significantly adversely affect the casting process (e.g., flowability, polymerization), machinability, and/or other processing of cast nylon parts.

### A. First Additive

An example of the first additive that may be used to form an example nylon composition of the present invention is acetylene black (e.g., acetylene carbon black). The example first additive has a very low bulk density of approximately 110 kg per cubic meter. When uncrushed, the first additive has a thixotropic effect on the base mixture. To maintain this thixotropic effect, the first additive (e.g., acetylene black) should be gently stirred and not be placed under high mechanical forces when added to the base mixture and when the resulting nylon composition mixture is placed into the mold. The term “gently stirred” refers to a mixing action that does not break down the acetylene black polymer-like chains. In any event, the mixing of the acetylene black into the base mixture should not involve high shear or milling action mixers to obtain a concentrate batch and likewise should not use such methods in the caprolactam heating and dispensing reactors. As one example, the mixer in the reactor may be run at a maximum rotational speed of approximately 100 RPM, and the impellor may have a 45 degree blade angle and a diameter that does not exceed approximately 200 millimeters. In this example, the maximum circumferential velocity does not break down the acetylene black polymer-like chains when the acetylene black is added to and mixed with the base mixture and when the resulting nylon composition mixture is placed into the mold.

The Applicant has discovered that the first additive provides the finished cast nylon part with enhanced conductivity properties. In particular, the first additive effectively forms a conductive, lattice-like structure within the finished cast nylon part. When handled correctly (e.g., not crushed during mixing of the nylon composition or casting of the nylon part), the bulk density of the first additive such as acetylene black is not broken down, facilitating the formation of the lattice-like structure within the mass of the finished cast nylon part. The complete lattice structure within the finished cast nylon part appears to be fully formed on the x, y, and z axes of a coordinate system defined to include the cast nylon part.

As examples, the Applicant has further determined that adding a first range of approximately 1.5-2.0% by weight of the first additive to the base monomer yields a resistivity of the cast nylon part of less than approximately 100,000 ohms, while adding approximately 1.0-1.5% by weight of the first additive to the base monomer yields a resistivity of the cast nylon part of approximately 1 M ohm to 1 G ohm. However, at least some of the benefits of the present invention may be obtained by adding a second range of approximately 0.1-7.0% by weight of the first additive. In any event, enough of the first additive should be added to the base mixture to obtain a cast part having a resistivity of approximately 250,000 ohms, but the resistivity may be within a first range of approximately 100,000 to 300,000 ohms and in any event should be within a second preferred range of 6,000 to 50,000,000,000 ohms.

The use of the first additive as an additive within the parameters defined in the examples below does not significantly adversely affect the flowability or polymerization of the active base mixture (base monomer, catalyst, and activator). Accordingly, a nylon composition of the present invention may be cast using conventional pour casting, reaction injection molding, and spin casting techniques. Used within the parameters defined in the examples below, the first additive further does not significantly adversely affect the operating characteristics, machinability, and/or further processing of the cast nylon part.

### B. Second Additive

An example of a second additive that may be used to form an example nylon composition of the present invention is nonyl phenol ethoxylate, but pure silicon oil having a viscosity of up to approximately 1000 cP or other chemically compatible non ionic surfactants having viscosity similar to that of nonyl phenol ethoxylate may be used instead or in addition. A finished cast nylon part containing the example second additive within the parameters described in the examples below yields a finished cast nylon part that inhibits break away of the caprolactam monomer as a result of pyrolysis. The break away caprolactam monomer has a very low viscosity and aids the pyrolysis of the cast nylon part. The addition of the second additive reduces this low viscosity run away product of combustion by itself breaking away, and, being of much higher viscosity (e.g., approximately 2000 to 10,000 cP) than the viscosity of the break away caprolactam polymer (e.g., melted (above 69 degrees Celsius) approximately 0.84 to 1.00 cP), the second additive acts as an aid to the inhibition of combustion. A cast nylon part without the second additive or any other fire retardant burns rapidly and continuously when subjected to a flame of around 1000 degrees Celsius for 30 seconds. In contrast, a cast nylon part comprising the second additive burns much more slowly and occasionally self-extinguishes when subjected to a flame of around 1000 degrees Celsius for 30 seconds.

The use of the second additive within the parameters defined in the examples below thus does not significantly adversely affect the flowability and/or polymerization of the base mixture (active base monomer containing the catalyst and activator). Accordingly, nylon composition of the present invention may be cast using conventional pour casting and spin casting techniques. Used within the parameters defined in the examples below, the second additive further does not significantly adversely affect the operating characteristics, machinability, and/or further processing of the cast nylon part.

### C. Third Additive

A third additive that may be used to form an example nylon composition of the present invention is at least one of silicon dioxide or fumed silica. The third additive is a thixotropic that allows example formulations of cast nylon compositions to include normally inorganic additives from sedimenting out or being spun out by centrifugal forces during spin casting. In particular, additives of higher density tend to sediment out or spin out before the viscosity of the base monomer, catalyst, and activator is sufficiently high to inhibit sedimentation or centrifugal separation during polymerization.

The third additive is very heat resistant and also acts as a flame retardant when combined with the base mixture. When the third additive is combined with the base mixture without the first and/or second additives, the third additive tends to form a dry outer shell or intumescent layer formed by the third additive, and the break away caprolactam polymer tends to “wick” into this outer shell or layer. In contrast, when the third additive is used in combination with the second additive, the relatively high viscosity of the second additive inhibits the flow of the free caprolactam and tends to reduce this “wicking” of the break away caprolactam polymer into the outer shell or intumescent layer formed by the third additive.

When used together, the quantity of the third additive will be balanced with the quantity of the first additive. For example, approximately 1.0-6.0% of silicon dioxide and approximately 1.0-1.5% of acetylene black may be added to the base mixture to obtain a nylon composition containing high density additives that would otherwise sediment out or separate out during conventional pour molding or spin molding techniques.

The use of the third additive within the parameters defined in the examples below further does not significantly adversely affect the operating characteristics, machinability, and/or further processing of the cast nylon part.

### D. Fourth Additive

A fourth additive that may be used to form an example nylon composition of the present invention is expandable graphite or intercalated graphite. The fourth additive is a fire retardant material. Expandable graphite is flaked graphite that is intercalated with a compound having a predetermined boiling point or exfoliating temperature. For example, sulfuric acid may be arranged between the graphene layers that form the graphite flake. When the exfoliating temperature is reached, the graphene layers are separated such that the flake remains complete or whole but expands substantially between 20 and 300 times the original volume of the flake. Graphite is a pure carbon structure that is highly stable and does not decompose at typical fire temperatures. Expandable graphite has a start expansion temperature (S.E.T.) of approximately 150-300 degrees Celsius. Accordingly, when a cast nylon body containing the fourth additive rapidly warms from room temperature to over 500 degrees Celsius, the fourth additive (e.g., expandable graphite) exfoliates or expands at the S.E.T. (e.g., 300 degrees Celsius) to form a soft, furry char that significantly reduces heat input into (insulates) the nylon mass, thereby inhibiting ignition of the nylon mass.

Additionally, the Applicants have found that expanding graphites having a S.E.T. temperature in the range of approximately 140 to 170 degrees Celsius act as blowing agents in the base mixture during polymerization. Accordingly, nylons having lower densities and other properties can be produced using the fourth additive because of these blowing agent properties. Further, expandable graphites having a S.E.T. of approximately 180 to 300 degrees Celsius are effective as intumescent forming agents in cast nylon during pyrolysis.

The use of the fourth additive within the parameters defined in the examples below further does not significantly adversely affect the operating characteristics, machinability, and/or further processing of the cast nylon part.

### E. Additional Additives

The benefits obtained by one or more of the first, second, third, and fourth additives, and/or combinations thereof, may be obtained with the use of additional additives not specifically described or disclosed herein. Accordingly, the formulations described herein may be supplemented with additional materials compatible with the base mixture and any of the additives used for a particular operating environment.

### II. EXAMPLE FORMULATIONS AND METHODS

In this section, a number of example formulations will be described along with detailed descriptions of the methods of combining the components of several of the example formulations.

### A. First Example

In the following Tables A-1 and A-2, each component of two related versions of a first example formulation of a nylon composition is identified and defined by numerical values as a percentage by weight of the base monomer prior to casting. In the example formulations described herein, the percentages by weight of each of the components combined to form the pre-cast composition are substantially the same as the percentage by weight of each of the components forming the cast nylon part formed from the pre-cast composition.

TABLE A-1

| Component | Example | First Range | Second Range |
|---|---|---|---|
| monomer | — | — | — |
| activator | 2.5 | 1.5 to 2.5 | 0.5 to 3 |
| catalyst | 2.5 | 2.0 to 2.8 | 1.6 to 5.0 |
| first additive | 1.5 | 1.6-3.0 | 1.5 to 3.0 |
| second additive | 2.0 | 1.5 to 2.0 | 1.0 to 2.5 |
| third additive | 3.0 | 2.0 to 3.5 | 1.0 to 5.0 |
| fourth additive | 5 | 4 to 7 | 4 to 10 |

TABLE A-2

| Component | Example | First Range | Second Range |
|---|---|---|---|
| monomer | — | — | — |
| activator | 2.5 | 1.5-2.5 | 0.1-6.0 |
| catalyst | 2.5 | 2.0-2.8 | 0.1-10.0 |
| first additive | 1.5 | 1.6-3.0 | 0.1-7.0 |
| second additive | 2.0 | 0.5-2.0 | 0.1-4.0 |
| third additive | 3.0 | 0.5-3.5 | 0.1-7.0 |
| fourth additive | 5 | 4 to 7 | 0.1-20.0 |

### B. Second Example

In the following Tables B-1 and B-2, each component of two related versions of a second example nylon composition is identified and defined by numerical values as a percentage by weight of the entire nylon composition prior to casting. In the example formulations described herein, the percentages by weight of each of the components combined to form the pre-cast composition are substantially the same as the percentage by weight of each of the components forming the cast nylon part formed from the pre-cast composition.

TABLE B-1

| | | First | |
|---|---|---|---|
| Component | Example | Range | Second Range |
| monomer | — | — | — |
| activator | 2.5 | 1.5 to 2.5 | 0.5 to 3.0 |
| catalyst | 2.5 | 2.0 to 2.8 | 1.6 to 5.0 |
| first additive | 1.5 | 1.5 to 2.0 | 1.5 to 3.0 |
| third additive | 3.0 | 2.0 to 3.5 | 1.0 to 5.0 |

TABLE B-2

| Component | Example | First Range | Second Range |
|---|---|---|---|
| monomer | — | — | — |
| activator | 2.5 | 1.5-2.5 | 0.1-6.0 |
| catalyst | 2.5 | 2.0-2.8 | 0.1-10.0 |
| first additive | 1.5 | 1.5-2.0 | 0.1-7.0 |
| third additive | 3.0 | 0.5-3.5 | 0.1-7.0 |

### C. Third Example

In the following Tables C-1 and C-2, each component of two related versions of a third example nylon composition is identified and defined by numerical values as a percentage by weight of the entire nylon composition prior to casting. In the example formulations described herein, the percentages by weight of each of the components combined to form the pre-cast composition are substantially the same as the percentage by weight of each of the components forming the cast nylon part formed from the pre-cast composition.

TABLE C-1

| Component | Example | First Range | Second Range |
|---|---|---|---|
| monomer | — | — | — |
| activator | 2.0 | 1.5 to 2.5 | 0.5 to 3.0 |
| catalyst | 2.5 | 2.0 to 3.0 | 1.6 to 5.0 |
| second additive | 2 | 1.5 to 2.0 | 1.5 to 3.0 |
| third additive | 3 | 2.0 to 3.5 | 1.0 to 5.0 |

TABLE C-2

| Component | Example | First Range | Second Range |
|---|---|---|---|
| monomer | — | — | — |
| activator | 2.0 | 1.5-2.5 | 0.1-6.0 |
| catalyst | 2.5 | 2.0-3.0 | 0.1-10.0 |
| second additive | 2 | 0.5-2.0 | 0.1-4.0 |
| third additive | 3 | 0.5-3.5 | 0.1-7.0 |

### D. Fourth Example

In the following Tables D-1 and D-2, each component of two related versions of a fourth example formulation of a nylon composition is identified and defined by numerical values as a percentage by weight of the entire nylon composition prior to casting. In the example formulations described herein, the percentages by weight of each of the components combined to form the pre-cast composition are substantially the same as the percentage by weight of each of the components forming the cast nylon part formed from the pre-cast composition.

TABLE D-1

| Component | Example | First Range | Second Range |
|---|---|---|---|
| monomer | — | — | — |
| activator | 2.5 | 1.5 to 2.5 | 0.5 to 3.0 |
| catalyst | 2.5 | 2.0 to 3.0 | 1.6 to 5.0 |
| first additive | 1.5 | 1.5 to 2.0 | 1.5 to 3.0 |
| third additive | 3 | 2.0 to 3.5 | 1.0 to 5.0 |
| fourth additive | 5 | 4 to 6 | 4 to 10 |

TABLE D-2

| Component | Example | First Range | Second Range |
|---|---|---|---|
| monomer | — | — | — |
| activator | 2.5 | 1.5-2.5 | 0.1-6.0 |
| catalyst | 2.5 | 2.0-3.0 | 0.1-10.0 |
| first additive | 1.5 | 1.5-2.0 | 0.1-7.0 |
| third additive | 3 | 0.5-3.5 | 0.1-7.0 |
| fourth additive | 5 | 4-6 | 0.1-20.0 |

### E. Fifth Example

In the following Tables E-1 and E-2, each component of two examples of a fifth example formulation of a nylon composition is identified and defined by numerical values as a percentage by weight of the entire nylon composition prior to casting. In the example formulations described herein, the percentages by weight of each of the components combined to form the pre-cast composition are substantially the same as the percentage by weight of each of the components forming the cast nylon part formed from the pre-cast composition.

TABLE E-1

| Component | Example | First Range | Second Range |
|---|---|---|---|
| monomer | — | — | — |
| activator | 2.5 | 1.5 to 2.5 | 0.5 to 3.0 |
| catalyst | 2.5 | 2.0 to 3.0 | 1.6 to 5.0 |
| second additive | 1.5 | 1.5 to 2.0 | 1.5 to 3.0 |
| third additive | 3 | 2.0 to 3.5 | 1.0 to 5.0 |
| fourth additive | 5 | 4 to 6 | 4 to 10 |

TABLE E-2

| Component | Example | First Range | Second Range |
|---|---|---|---|
| monomer | — | — | — |
| activator | 2.5 | 1.5-2.5 | 0.1-6.0 |
| catalyst | 2.5 | 2.0-3.0 | 0.1-10.0 |
| second additive | 1.5 | 0.5-2.0 | 0.1-4.0 |
| third additive | 3 | 0.5-3.5 | 0.1-7.0 |
| fourth additive | 5 | 4-6 | 0.1-20.0 |

### F. Sixth Example

In the following Table F, each component of a sixth example nylon composition is identified and defined by numerical values in grams. In the example formulations described herein, the numerical values defining the amount of each of the components combined to form the pre-cast composition are substantially the same as each of the components forming the cast nylon part formed from the pre-cast composition.

TABLE F

| | | First | Second |
|---|---|---|---|
| Component | Example | Preferred Range | Preferred Range |
| caprolactam monomer | 200 g | — | — |
| activator | 5.0 g | 3.0-5.0 g | 3.0-6.0 g |
| catalyst | 6.0 g | 5.0-7.0 g | 3.0-10.0 g |
| acetylene black | 3.0 g | 3.0-4.0 g | 2.0-6.0 g |
| nonyl pheonol | 4.0 g | 3.0-5.0 g | 2.0-8.0 g |
| ethoxylate | | | |
| silicon dioxide | 6.0 g | 5.0-7.0 g | 4.0-10.0 g |
| expandable graphite | 20 g | 18.0-22.0 g | 15.0-30.0 g |

The components of the sixth example nylon composition are combined as follows.

All additives are conventionally pre-treated.

To an accurately temperature controlled stainless steel container 200 grams of caprolactam is added. The container operates at 157 degrees Celsius and has a lid with anhydrous nitrogen bleeding over the top of the cavity at a rate of 30 litres per hour. The acetylene black and silicon dioxide are next added to the container. The nonyl phenol ethoxylate and activator for cast nylon are next added to the container. The highly viscous mixture is well mixed. The expandable graphite is next added to the container, and the mixture is again agitated to render a homogenous dispersion of components therein. The cast nylon catalyst is added, and the mixture is gently agitated to achieve a substantially homogenous dispersion. Polymerisation commences, and a solid sample or piece of cast nylon 6 is made with mechanical properties within the typical range.

The specific resistance of the sample created as described above is approximately 210,000 ohms between a 1 cm gap.

In addition, a test piece is cut out from the sample and machined to 13×13×150 mm. A vertical burn test is conducted by holding a flame of 1000 degrees Celsius to the bottom of the sample at 0 to 45 degrees in a test enclosure (as per the UL94 V0 specifications). A cotton cloth is arranged below the test piece to monitor flaming drips. The flame is applied to the test piece and removed as per the test specification. The sample intumesces within 3 seconds of the flame touching it. Worm like pieces of exfoliated graphite shoot out of the surface and form a char barrier. The flame melts part of the vertical surfaces of the sample. Once the flame is removed the sample continues to burn for 3 seconds and then the flame self-extinguishes. No drips are seen on the cotton cloth.

### G. Seventh Example

In the following Table G, each component of a seventh example nylon composition is identified and defined by numerical values in grams. In the example formulations described herein, the numerical values defining the amount of each of the components combined to form the pre-cast composition are substantially the same as each of the components forming the cast nylon part formed from the pre-cast composition.

TABLE G

| | | First | Second |
|---|---|---|---|
| Component | Example | Preferred Range | Preferred Range |
| laurolactam monomer | 200 g | — | — |
| activator | 0.75 g | 0.50-0.90 g | 0.35-1.0 g |
| (Carbodiimide) | | | |
| catalyst | 6.0 g | 5.0-6.0 g | 4.0-10.0 g |
| acetylene black | 4.0 g | 2.0-6.0 g | 0.2-6.0 g |
| nonyl pheonol | 4.0 g | 3.0-4.0 g | 1.0-4.0 g |
| ethoxylate | | | |
| silicon dioxide | 6.0 g | 4.0-7.0 g | 2.0-7.0 g |
| expandable graphite | 12 g | 10.0-15.0 g | 8.0-20 g |

The present invention may be applied to monomers in addition to capolactam monomers. This seventh example nylon composition comprises laurolactam (C12H23NO). Laurolactam is a cyclic lactam used to make Nylon 12 (polyamide 12).

All additives are pre-treated in the usual way as known to those skilled in the art.

The laurolactam is added to an accurately temperature controlled stainless steel container operating at 157 degrees Celsius and having a lid with anhydrous nitrogen bleeding over the top of the cavity at a rate of 30 litres per hour. The acetylene black and the silicon dioxide are added to the container. The nonyl phenol ethoxylate and carbodiimide as the activator for cast nylon are next added. The highly viscous mixture is well mixed. The expandable graphite is next added, and the mixture is again agitated to render a homogenous dispersion of components therein. Sodium laurolactamate (laurolactam pre-reacted with 3.5% sodium metal) is added as the catalyst and is gently agitated in to achieve a homogenous dispersion. Polymerisation commences and solid piece of cast nylon 12 is made with mechanical properties within the typical range.

The specific resistance of the solid piece of cast nylon 12 of this seventh example composition is approximately 240,000 ohms between a 1 cm gap.

Additionally, a test piece is cut out and machined to 13×13×150 mm. A vertical burn test is conducted by holding a flame of 1000 degrees Celsius to the bottom of the sample at 0 to 45 degrees in a test enclosure (as per UL94 V0 specifications). A cotton cloth is placed below the test piece to monitor flaming drips. The flame is applied and removed as per the test specification. The sample intumesces within 3 seconds of the flame touching it. Worm like pieces of exfoliated graphite shoot out of the surface and form a char barrier. The flame melts part of the vertical surfaces of the sample. Once the flame is removed the sample continues to burn for 4 seconds and then the flame self-extinguishes. No drips are seen on the cotton cloth.

### H. Eighth Example

In the following Table H, each component of an eighth example nylon composition is identified and defined by numerical values in grams. In the example formulations described herein, the numerical values defining the amount of each of the components combined to form the pre-cast composition are substantially the same as each of the components forming the cast nylon part formed from the pre-cast composition.

TABLE H

| | | First | | Second | |
|---|---|---|---|---|---|
| Component | Example | Preferred Range | | Preferred Range | |
| caprolactam monomer | 140 g | 140 to 196 | g | 180 to 196 | g |
| laurolactam monomer | 60 g | 55-65 | g | 50-70 | g |
| activator | 5.0 g | 1.0-5.0 | g | 1.0-6.0 | g |
| catalyst | 6.0 g | 5.0-6.0 | g | 4.0-10.0 | g |
| acetylene black | 4.0 g | 2.0-6.0 | g | 0.2-6.0 | g |
| nonyl pheonol | 4.0 g | 3.0-4.0 | g | 1.0-4.0 | g |
| ethoxylate | | | | | |
| silicon dioxide | 6.0 g | 4.0-7.0 | g | 2.0-7.0 | g |
| expandable graphite | 12 g | 10.0-15.0 | g | 8.0-20 | g |

All additive components of this eighth example nylon composition are pre-treated in the usual way as known to those skilled in the art.

The Caprolactam is added to an accurately temperature controlled stainless steel container. The Laurolactam is then added to form a nylon 6/12 co-polymer. The co-polymer of laurolactam can be added from 2% to 30% laurolactam in relation to caprolactam monomer.

The temperature of the container is controlled to a level of 157 degrees Celsius, and anhydrous nitrogen is bled over the top of a cavity of a lid of the container at a rate of 30 litres per hour. The acetylene black and the silicon dioxide are next added. The nonyl phenol ethoxylate and activator for cast nylon are next added. The mixture, which is highly viscous, is well mixed. The expandable graphite is next added, and the mixture is again agitated to render a homogenous dispersion of components therein. Cast nylon catalyst is then added, and the mixture is gently agitated to achieve a homogenous dispersion. Polymerisation commences and a solid piece of cast nylon 6/12 is made with mechanical properties within the desired range.

The specific resistance of the solid piece of cast nylon 6/12 is found to be approximately 280,000 ohms between a 1 cm gap.

A test piece is cut out and machined to 13×13×150 mm. A vertical burn test is conducted by holding a flame of 1000 degrees Celsius to the bottom of the sample at 0 to 45 degrees in a test enclosure (as per the UL94 V0 specifications). A cotton cloth is arranged below the test piece to monitor flaming drips. The flame is applied and removed as per the test specification. The sample intumesces within 3 seconds of the flame touching it. Worm like pieces of exfoliated graphite shoot out of the surface and form a char barrier. The flame melts part of the vertical surfaces of the sample. Once the flame is removed, the sample continues to burn for 4 seconds and then the flame self-extinguishes. No drips are seen on the cotton cloth.

### III. EXAMPLE CAST NYLON PART

As briefly mentioned above, a cast nylon part made using the principles of the present invention is of relevance in any environment in which the properties of conventional cast nylon are desirable but conventional cast nylon cannot be used because of the undesirable anti-static and fire retardant properties of conventional cast nylon parts. As one example, a cast nylon part may be used for any mechanical component where the build-up of static potential difference is unacceptable, such as in the processing and handling of flammable liquids or solids such as explosives.

Additional examples of cast nylon parts that can be made in accordance with the principles of the present invention include belt scrapers for conveyor belts, jigs for manual or robotic assembly lines for electrical circuit boards and/or microchips (semiconductors), drill bit guides used in mining where the mineral being mined or the environment is subject to ignition in the event of static discharge, glass filled nylon tubes, mechanical cable guides and parts for material handling systems designed to operate in flammable environments, tools such as mallet heads intended for use underground, instrumentation housings and inner bodies for use in environments in which intrinsically safe instruments are required, conductive elevator buckets for use in environments such as silos where risk of dust explosion is present, conductive wheels for use on trolleys, machined conduit ends for flexible housings for electrical cable, tubes or conduits for carrying air or other fluids where the air or other fluids needs to be electrically neutral.

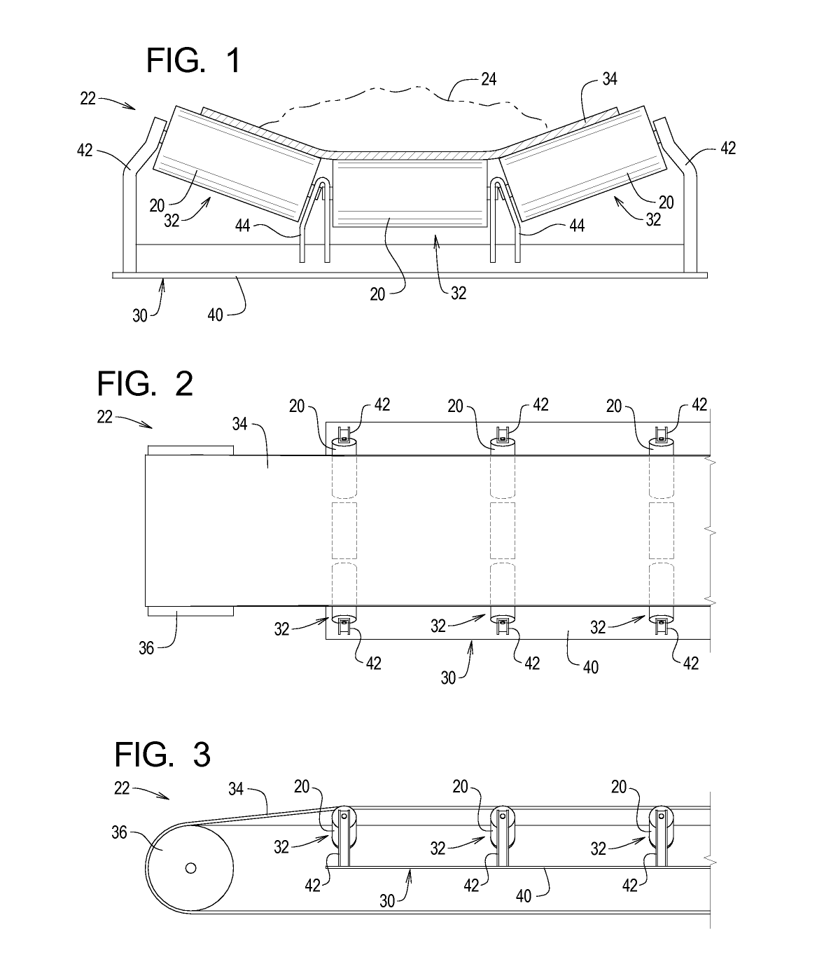

One example of a cast nylon part made using the principles of the present invention is used as part of a conveyor belt system. Referring now to FIG. 1, depicted therein is a plurality of roller structures 20 embodying a cast nylon part made using any one of the example cast nylon compositions as described above. The roller structures 20 are used as part of a material handling system or conveyor system 22 adapted to transport material 24.

The example material handling system 22 comprises a frame 30, a plurality of idlers 32, a belt 34, and a drum 36. In particular, the frame 30 comprises a frame base 40, first and second side brackets 42, and first and second intermediate brackets 44.

As is well known in the art, the brackets 42 and 44 support the idlers 32, and the idlers 32 in turn support the belt 34. The drum 36 engages the belt 34 and is rotated by a motor (not shown) to displace the belt 34. The material 24 is arranged on the upper side of the belt and is displaced along with the belt 34 when the drum 36 is rotated. The frame 30, belt 34, and drum 36 are or may be conventional and will be described herein only to the extent necessary for a complete understanding of the present invention.

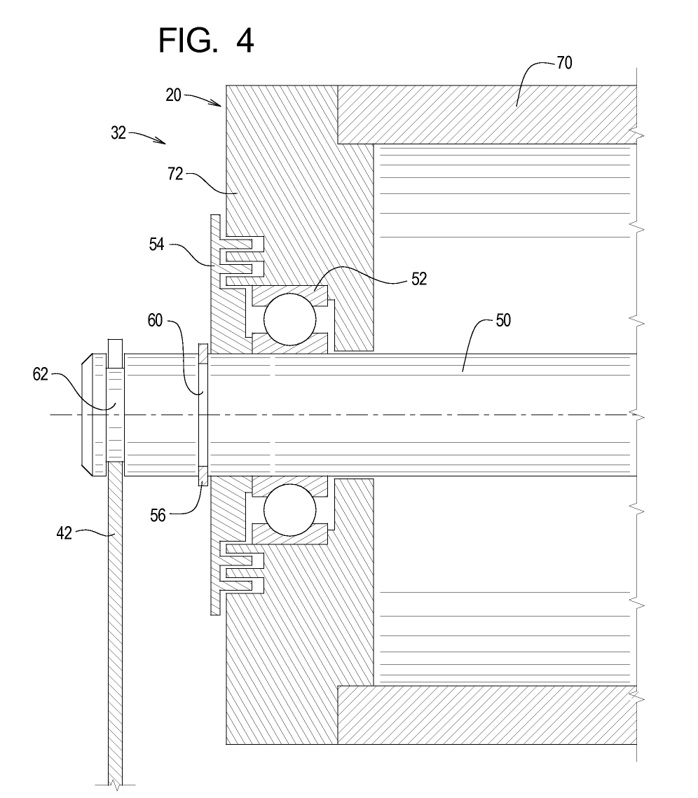

The idlers 32 comprise, in addition to the roller structures 20, a shaft 50, a pair of bearings 52, a pair of shields 54, and a pair of clips 56. Each end of the shaft 50 defines first and second grooves 60 and 62. The roller structures 20 each comprise a roller body 70 and a pair of end caps 72. Only one of the bearings 52, shields 54, clips 56, and grooves 60 and 62 is shown in FIG. 4 for clarity.

The roller body 70 is a solid piece of spin-casted nylon using one of the example cast nylon compositions described above. The example end caps 72 are typically injection molded pieces made of a material that is compatible with the cast nylon composition of the roller body 70. In particular, the example end caps 72 are made of a nylon material that allows the end caps 72 to be spin welded to the roller body 70 to form a rigid connection between the roller body 70 and the end caps 72. The roller structures 20 thus take the form of a cylindrical body with narrowed holes or openings defined by the end caps 72. The shape of the end caps 72 is defined by the designs of the bearings 52, the shields 54, and the roller body 70, and the shape of the end caps 72 may be modified to accommodate bearings, shields, and roller bodies of different designs from those depicted in FIG. 4. In any event, the end caps 72 should effectively transmit the loads on the roller body 70 to the shaft 50 through the bearings 52.

Once the roller body 70 is formed, the shaft 50 is inserted through holes or openings in the end caps 72, and one of the bearings 52 is arranged on each end of the shaft 50 between the shaft 50 and one of the end caps 72. The shields 54 are next placed on each end of the shaft 50, and the clips 56 are arranged to engage the first grooves 60 and thus maintain the shaft 50 in a predetermined orientation with respect to a longitudinal axis of the roller structure 20. However, the bearings 52 allow axial rotation of the roller structure 20 relative to the shaft 50.

The second grooves 62 each engage one of the side brackets 42 to support one end of the shaft 50 and the other end of the shaft 50 on one of the intermediate brackets 44 (not visible in FIG. 4) to support the shaft 50 relative to the frame 30. The roller structures 20 also axially rotate about the shafts 50 and thus relative to the frame 30.

The roller bodies 70 are spin-casted by arranging the cast nylon composition formed by the base mixture and the additives within a hollow mold tube (not shown) before the monomer polymerizes. The mold tube is then rotated at high speed such that the base mixture and additives are spun by centrifugal force to form an even layer on the inside of the mold tube. When the cast nylon composition polymerizes, it forms the roller body 70 in the form of a hollow cylindrical tube. The spin welding process is well known and will not be described in additional detail herein.

What is claimed is:

1. A composition for forming a cast nylon part comprising:
a base caprolactam mixture, and
at least one of
a first additive comprising acetylene carbon black;
a second additive comprising at least one of nonyl phenol ethoxylate, silicon oil, and at least one nonionic surfactant having a viscosity similar to that of nonyl phenol ethoxylate;
a third additive comprising silicon dioxide; and
a fourth additive comprising intercalated expandable graphite.

2. A composition as recited in claim 1 comprising the first, second, third, and fourth additives.

3. A composition as recited in claim 2, in which the composition comprises, as a percentage by weight of the base monomer prior to casting, approximately 1.5-3.0 of the first additive, 1.0-2.5 of the second additive, 1.0-5.0 of the third additive, and 4-10 of the fourth additive.

4. A composition as recited in claim 2, in which the composition comprises, as a percentage by weight of the base monomer prior to casting, approximately 0.1-7.0 of the first additive, 0.1-4.0 of the second additive, 0.1-7.0 of the third additive, and 0.1-20.0 of the fourth additive.

5. A composition as recited in claim 1 comprising the first and third additives.

6. A composition as recited in claim 2, in which the composition comprises, as a percentage by weight of the base monomer prior to casting, approximately 1.5-3.0 of the first additive and 1.0-5.0 of the third additive.

7. A composition as recited in claim 2, in which the composition comprises, as a percentage by weight of the base monomer prior to casting, approximately 0.1-7.0 of the first additive and 0.1-7.0 of the third additive.

8. A composition as recited in claim 1 comprising the second and third additives.

9. A composition as recited in claim 8, in which the composition comprises, as a percentage by weight of the base monomer prior to casting, approximately 1.0-2.5 of the second additive and 1.0-5.0 of the third additive.

10. A composition as recited in claim 8, in which the composition comprises, as a percentage by weight of the base monomer prior to casting, approximately 0.1-4.0 of the second additive and 0.1-7.0 of the third additive.

11. A composition as recited in claim 1 comprising the first, third, and fourth additives.

12. A composition as recited in claim 11, in which the composition comprises, as a percentage by weight of the base monomer prior to casting, approximately 1.5-3.0 of the first additive, 1.0-5.0 of the third additive, and 4-10 of the fourth additive.

13. A composition as recited in claim 11, in which the composition comprises, as a percentage by weight of the base monomer prior to casting, approximately 0.1-7.0 of the first additive, 0.1-7.0 of the third additive, and 0.1-20.0 of the fourth additive.

14. A composition as recited in claim 1 comprising the second, third, and fourth additives.

15. A composition as recited in claim 14, in which the composition comprises, as a percentage by weight of the base monomer prior to casting, approximately 1.0-2.5 of the second additive, 1.0-5.0 of the third additive, and 4-10 of the fourth additive.

16. A composition as recited in claim 14, in which the composition comprises, as a percentage by weight of the base monomer prior to casting, approximately 0.1-4.0 of the second additive, 0.1-7.0 of the third additive, and 0.1-20.0 of the fourth additive.

17. A composition as recited in claim 1, in which:
the coprolactam polymer comprises
coprolactam monomer,
activator, and
catalyst; and
the composition comprises
acetylene black as the first additive,
nonyl phenol ethoxylate as the second additive,
silicon dioxide as the third additive, and
expandable graphite as the fourth additive.

18. A composition as recited in claim 1, in which:
the coprolactam polymer comprises
laurlolactam monomer,
activator, and
catalyst; and
the composition comprises
acetylene black as the first additive,
nonyl phenol ethoxylate as the second additive,
silicon dioxide as the third additive, and
expandable graphite as the fourth additive.

19. A composition as recited in claim 1, in which:
the coprolactam polymer comprises
caprolactam monomer,
laurlolactam monomer,
activator, and
catalyst; and
the composition comprises
acetylene black as the first additive,
nonyl phenol ethoxylate as the second additive,
silicon dioxide as the third additive, and
expandable graphite as the fourth additive.

20. A method of forming a cast nylon part comprising:
providing a base caprolactam mixture, and
adding to the base caprolactam mixture at least one of
a first additive comprising acetylene carbon black;
a second additive comprising at least one of nonyl phenol ethoxylate, silicon oil, and at least one nonionic surfactant having a viscosity similar to that of nonyl phenol ethoxylate;
a third additive comprising silicon dioxide; and
a fourth additive comprising intercalated expandable graphite.
